(19) United States
(12) Patent Application Publication
(10) Pub. No.: US 2017/0286974 A1
(43) Pub. Date: Oct. 5, 2017

(54) METHOD AND AUTHENTICATION SYSTEM FOR REGISTERING A RANDOM SECURITY FEATURE

(71) Applicant: AUTHENTIC VISION GMBH, Salzburg (AT)

(72) Inventors: Thomas Weiss, Salzburg (AT); Thomas Bergmüller, Salzburg (AT)

(21) Appl. No.: 15/507,943

(22) PCT Filed: Sep. 1, 2015
(86) PCT No.: PCT/EP2015/069893

§ 371 Date: Mar. 1, 2017

(30) Foreign Application Priority Data
Sep. 1, 2014 (EP) 14183070.3

(51) Int. Cl. G06Q 30/00; G06F 21/73

(52) U.S. Cl. CPC G06Q 30/0185; G06F 21/73; H04L 9/3278

(57) ABSTRACT

The invention relates to a method and an authentication system for registering a random security feature (8) of a product (5) in a database (10) on the basis of a reproducible identification feature (6) of the product (5), wherein the security feature (8) is being linked to the identification feature (6), and said random security feature (8) is being registered on the condition that a preliminary authentication check (15) of the product (5) is positive, such that any subsequent definitive authentication checks of the product (5) may use the registered security feature.

### 1. TECHNICAL FIELD

The invention relates to a method for registering a random security feature of a product in a database on the basis of an identification feature of the product, wherein the security feature is being linked to the identification feature, and an authentication system for implementing the method, comprising a database storing links between identification features and security features of products, and a mobile reading device adapted to capture an identification feature and a random security feature on a product for authentication of the product.

### 2. DESCRIPTION OF RELATED ART

The present method serves the differentiation of original products and plagiarism, i.e. copies not authorized by the creator of the original product, and is thus part of a more comprehensive authentication method. In relation with such methods it is sufficiently known in the state of the art that optically capturable random object characteristics of the product are used as security features, which vary from object to object and are not or only difficult to reproduce. Alternatively or additionally, random features which are applied subsequently on the products and which are not removable may also be used as security features. Such or comparable security features will be called random security features in the following, which enable a marking of products which cannot or only with much effort be reproduced by unauthorized third parties and can thus not be counterfeited. The identification feature used is often a serial number which is usually generated and applied on the product in the course of production and is thus generally—in contrast to the random security features—already known prior to its application, on the one hand, and reproducible, on the other hand. The identification feature enables an unambiguous identification of a particular product. To facilitate authentication, the identification feature may be available in the form of a machine-readable code, e.g. as a one-dimensional or two-dimensional bar code, so that automatic reading-in and processing of the identification feature is considerably facilitated. During the checking of authenticity of a product the identification feature and the security feature are usually captured, and the captured security feature is compared with a security feature stored in a (for instance, central or centrally updatable) database and linked to the identification feature (in the strict sense their digital representations are compared). If they match, authenticity of the product is assumed. An electronic and/or computer-based database which is, for instance, operated on a database server is, as a rule, used as a database.

Such authentication methods may, for instance, be taken from WO 2007/111548 A1, GB 2460734 A, or US 2004/0230528 A1. The state of the art, however, only mentions in passing—if at all—how the registration of the random security features in the database takes place with the respective methods, i.e. how or when the corresponding database entries are made:

Only WO 2007/111548 A1 describes explicitly that the material characteristics are measured and stored in the database in advance, e.g. by the manufacturer prior to the delivery of the products; GB 2460734 A only mentions the basic possibility of extending the database with new entries, which is, however—taken as such—a matter of fact for databases, anyway; and in US 2004/0230528 A1 the serial number is generated on the basis of the object features, so that here, too, a link between the serial number and the object features is already made during the production (especially prior to the application of the serial number).

US 2013/277425 A1 relates to the protection of a supply chain i.a. from counterfeits by authentication of the goods at one or several points. The goods are to be provided with markings with a unique identification feature and a random security feature, wherein the marking may, for instance, be checked by means of a smart phone. During checking the security feature is captured and a detection is first of all made if it really is a 3D security feature. Subsequently its authenticity is checked possibly by comparison with the signature of an authentication pattern which is stored in a central database or locally on the article itself. For storing the signature the markings have to be captured and “activated” already during the production or delivery. Activating thus takes place under control of the manufacturer, i.e. in a safe surrounding and under trustworthy conditions. The authenticity of the goods and/or of the marking to be activated is guaranteed at this point of time by the external circumstances.

In Saloomeh Sharaiati et al., “Security Analysis of Image-Based PUFs for Anti-counterfeiting” (in: Communications and Multimedia Security, 13^{th} IFIP TC 6/TC 11 International Conference. Editor: De Decker et al. Springer Berlin Heidelberg, 2012, pp. 26-38) a formal analytic model for evaluating the security and robustness of minute laser engraving and/or the configuration, registration, and verification thereof is developed. Here, it is explicitly assumed that the registration is performed by the legitimate owner and only with components of trustworthy sources. Under such conditions, i.e. in a controlled, legitimate surrounding, the authenticity of the goods and/or the marking is also guaranteed by the external circumstances.

WO 2014/059439 A1 relates to a system for the registration of products in which a hidden security feature is used for authentication of the products. The security features used for authentication are generated at the computer and registered already during this process, i.e. under controlled, trustworthy conditions.

In the known methods, since the random security features are naturally not known in advance, the random security features must thus be captured at the creator and/or the manufacturer of the products, so that the links necessary for a later authentication may be established in the database or the implicitly linked identification features or signatures may be applied on the products. This means that the registration of the random security features is performed by the creator and/or the manufacturer of the products. Accordingly, the registration (or “activation”) of the random security features takes place under controlled, secure, and hence trustworthy conditions. Under such conditions authenticity of the security features which still have to be registered may be assumed. The capturing of the random security features at the creator and/or the manufacturer of the products is, however, of disadvantage in practice since it requires an adaptation of the available (manufacturing) processes. Thus, for instance, additional high performance cameras have to be added to the production line, the production speed possibly has to be decelerated (to give the cameras sufficient time for capturing the random security features), or even separate production steps have to be introduced.

### SUMMARY OF THE INVENTION

The object of the present invention consists in avoiding the above disadvantages and in proposing a method and a system which minimize necessary modifications of existing production processes during the introduction of a product authentication without, however, renouncing the counterfeit protection achieved by random security features.

This object is solved in that the random security feature is being registered on the condition that a preliminary authentication check of the product is positive, such that any subsequent definitive authentication checks of the product may use the registered security feature. This means that the registration of the random security feature, which—as indicated initially—comprises substantially the linking of the random security feature to an identification feature, is only performed if the preliminary authentication check confirms the authenticity of the product on the basis of the information available at this point of time. Essential for the preliminary authentication check is that it works—in contrast to the definitive authentication check—without previous registration of the random security feature. In contrast, the definitive authentication check is based on a check of the (already existing) linking of the identification and security features found on the product. The introduction of a preliminary authentication check naturally means an increase of the effort required for registration and thus appears to be disadvantageous at first. The decisive advantage results, however, from the out sourcing of the registration which is thus enabled. Due to the safeguarding of the registration by the preliminary authentication check it need no longer take place during the production, but is instead performed subsequently, preferably in the course of the first authentication of the product. Along with the registration, however, the capturing of the random security features can also be out sourced, so that the integration in the existing production process is substantially facilitated since no device for capturing is required at the creator. The reliability and security of the authentication method is not or hardly impaired by the out sourcing since in practice the first authentication is always performed by the trader and/or the purchaser of the original product (of which copies might possibly be made later), and as a rule under controlled conditions (e.g. directly at the authorized trader or in the distribution chain thereof), and since the preliminary authentication check offers more than sufficient protection under these circumstances. Later authentications resort to the then registered security features anyway and thus profit from the full counterfeit protection of the random security features irrespective of the external circumstances.

Accordingly, the object is solved with an authentication system of the initially mentioned kind, wherein the mobile reading device is adapted to perform and/or cause a preliminary authentication check of the product on the basis of the captured identification feature, and, if the preliminary authentication check is positive, to perform and/or cause a registration of the captured random security feature in the database.

A simple and simultaneously effective preliminary authentication check may consist in that the preliminary authentication check is negative if the identification feature is not registered in the database. The security achieved by this type of authentication check is based on the uniqueness of the identification feature and on its characteristic that it cannot be guessed by a counterfeiter. Such identification features may, for instance, be generated with the aid of a random generator and/or an encryption method. The number of possible feature combinations (i.e. the length of a serial number or generally the information content of the identification feature) should exceed the circulation of the respective product by far so as to guarantee the uniqueness, on the one hand, and to aggravate accidental guessing of a valid (i.e. registered) identification feature, on the other hand. The identification feature generated this way during the production is applied on a product, on the one hand, and registered in the database, on the other hand, but without linking to a random security feature—which has not yet been captured at this point of time. During the preliminary authentication check, e.g. during the first authentication, the identification feature applied on the product is detected and a corresponding entry is searched for in the database. If the detected identification feature is not found, the product is apparently a counterfeit and authentication fails, and hence also the registration of a security feature. If the detected identification feature is found and is already linked to a random security feature, a definitive authentication check is performed. A potential counterfeiter therefore would have to guess an identification feature of a product that has already been produced, but has never been authenticated yet, i.e. the characteristics of the identification feature itself are accompanied as an additional security by the comparatively narrow time window for the registration of the random security feature (wherein the time window—as will be described in the following—may be narrowed additionally). During the registration of the random security feature an existing database entry of the identification feature is accordingly completed; in particular no new database entry for the identification feature of the product will be generated. With respect to time, the registration of the random security feature is accordingly only possible after the registration of the identification feature.

Moreover, it is advantageous if, in the course of the preliminary authentication check, additional information associated with the identification feature, for instance, a target market and/or a sales period of the product and/or a reproducible security feature, is taken into account, in particular in connection with the current time and position of the product during the ongoing registration. Such associated information may be retrieved, for instance, with the aid of the identification feature from the database, where they were stored e.g. by the manufacturer during the production of the product and the registration of the identification feature, or they may be derived directly from the identification feature if they are embedded therein—e.g. in encrypted form. By means of the additional information the plausibility of a first authentication of the product is then determined under the likewise known circumstances (i.e. at a known point of time and possibly a known place). If little plausibility is determined, e.g. since the place of registration deviates from the target market or the point of time of registration is significantly beyond an intended sales period, the preliminary authentication check fails and the registration is cancelled.

The security of the preliminary authentication check may be further improved if, in the course of the preliminary authentication check, the plausibility of the random security feature to be registered is checked, in particular as a function of a product type or a product class associated with the identification feature. If all the possible random security features of one type or of one class have a joint characteristic such as, for instance, the belonging to an overall pattern (i.e. the security features comprise parts or sections from the overall pattern) or similar pattern characteristics, the captured (unregistered) random security features may be checked for this joint characteristic. Additionally, by means of the associated product type or the product class their joint, e.g. structural, features may be subject to a plausibility check which forms part of the preliminary authentication check.

The preferred aim of the present method is that the random security feature to be registered is captured by means of a mobile reading device, preferably by means of a sensor of a commercially available mobile terminal such as, for instance, a commercially available smart phone, and that the captured random security feature is transmitted from the mobile reading device to the database prior to registration. The random security feature may, for instance, be a random optical security feature readable by means of a digital camera of a mobile terminal. In such an authentication system, i.e. comprising a central database and a plurality of mobile reading devices communicating with the database, a central capturing of the security features may be omitted completely. Exclusively already existing and/or widely spread, commercially available terminals are preferably used as reading devices, so that no asset costs are incurred to the manufacturer or the database operator. Since the mobile reading device performing the registration transmits the captured random security feature (i.e. the digital representation of the physical random security feature) to the database, other mobile reading devices may subsequently access the captured random security feature, or the database may compare it at a later time with a captured random security feature transmitted by another mobile reading device.

Due to the wide spreading of suitable optical sensors and the increasing quality and optical resolution of these sensors it is particularly favorable if the random security feature to be registered is formed by optically capturable characteristics and is captured optically in the course of registration. Optical characteristics enable moreover high information density and are at the same time economically to produce (e.g. in comparison with electronic security features) and robust against mechanical or thermal damages or counterfeits.

In order to avoid faulty authentications in connection with the use of mobile reading devices (e.g. by other mobile reading devices used in parallel) while performing the present method, it is favorable if the captured random security feature is registered in the database and linked to the identification feature (only) after the positive authentication check. The preliminary authentication check may take place both locally at the mobile reading device or else centrally in the database (e.g. at the database server). If the preliminary authentication check is performed at the mobile reading device, the captured random security feature may e.g. be transmitted to the database only after a positive preliminary authentication check. If the preliminary authentication check is performed in the database and/or by a central server, the identification feature and the captured random security feature may e.g. be transmitted simultaneously to the database and/or the server.

Preferably, the preliminary authentication check is performed locally at the mobile reading device. Thus, excessive computing load for the central server due to possibly complex comparisons of complicated and comprehensive security features can be avoided. In order to nevertheless guarantee the highest possible protection from manipulations of the preliminary authentication check, the preliminary authentication check may also be implemented as a two-stage method with a check locally at the reading device and—in the case of a positive outcome—a further check centrally at the server.

The initially described advantages of the present method for the simplification and acceleration of a production process can be utilized in the full scope if the identification feature is, generated, applied on the product, and registered in the database in advance, in particular during or before the production of the product. If the identification feature is generated before the production, it may be made available for the production, for instance, with the aid of a data carrier. Capturing of the identification feature during the production is thus not necessary for the registration of the identification feature since it is known already prior to the application on the product. Due to the registration of the identification feature in the database during the production it is possible to use the identification feature as a component of the preliminary authentication check, and it is ensured that only identification features of actually produced products are registered in the database. Thus, the time window in with the identification feature could be guessed and a counterfeit could be provided therewith is further narrowed.

It is further favorable if the identification feature is represented by an identification code applied on the product. Such identification codes may be produced in a very favorable manner during or already prior to the production of the actual products and may possibly be used for the most various products. The identification code may, for instance, be adhered by means of an adhesive label or may be printed directly in the case of suitable product surfaces.

The identification code may be read in optically and processed in a particularly simple manner, in particular also automatically, if the identification code comprises the identification feature encoded in a machine-readable format, for instance, as a one-dimensional bar code or as a 2D code. Such codes may be processed with commercially available and widely spread optical sensors. In particular, with such codes—which are readily recognized and used as such—additional information and partially instructions concerning the authentication system may be integrated, so that an automatic user guidance through a preliminary and/or definitive authentication check may be achieved after the capturing and detection of the identification code (for which purpose—as mentioned—no particular technical provisions are required).

### BRIEF DESCRIPTION OF THE DRAWINGS

The present invention will be explained in detail by means of the following embodiments which it is not restricted to, though, and with reference to the drawings. The drawings show in detail:

FIG. 1 a schematic behavior diagram of an authentication system and method in accordance with the state of the art; and

FIG. 2 a schematic behavior diagram of an authentication system and method in accordance with the present invention.

### DETAILED DESCRIPTION

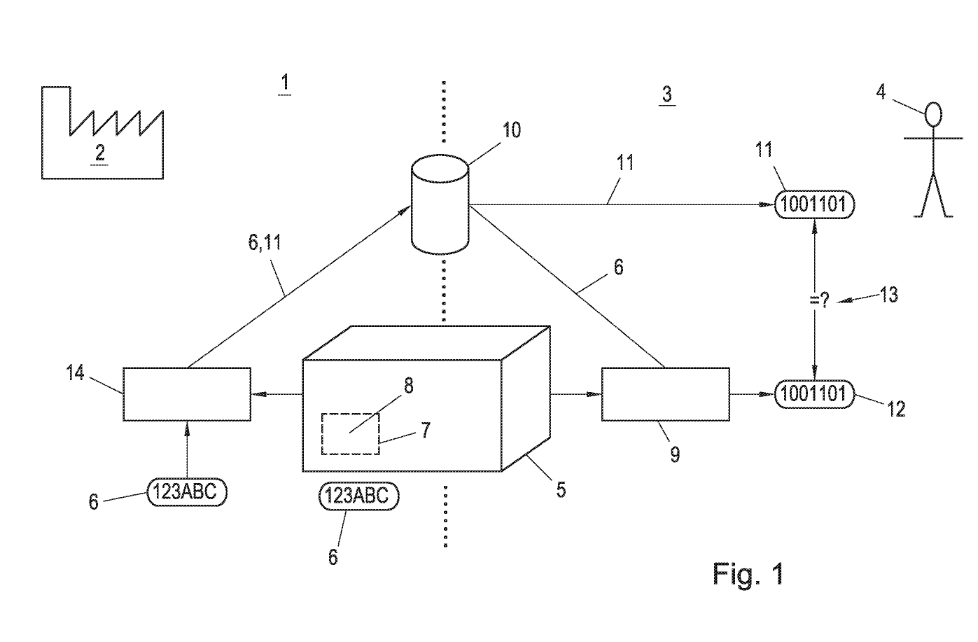

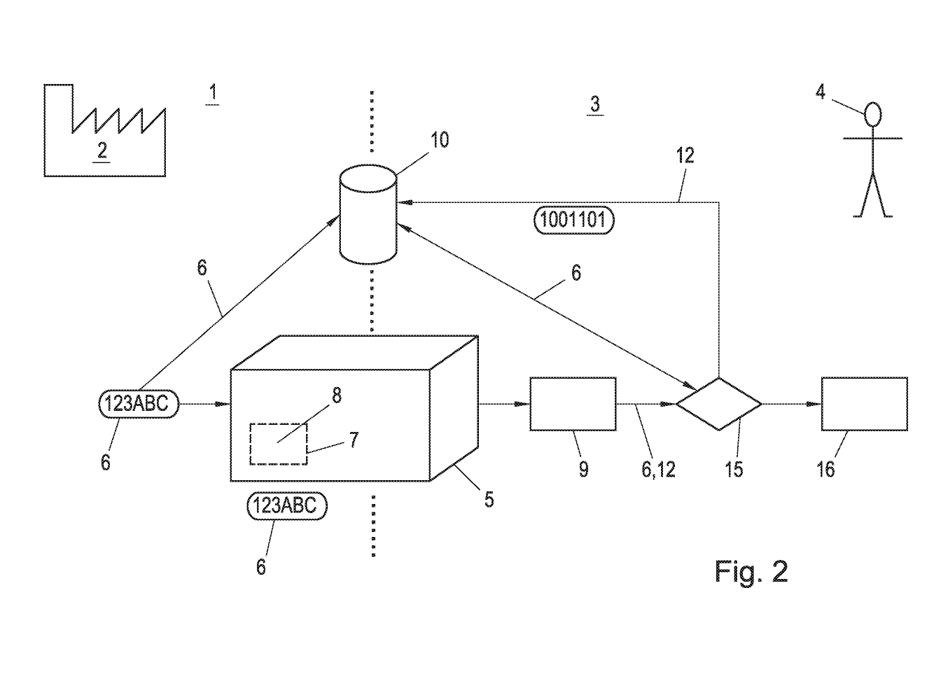

The diagrams in FIGS. 1 and 2 illustrate at the left side, the manufacturer side 1, the behavior of the manufacturer 2, and at the right side, the user side 3, the behavior of the user 4. In both cases the authenticity of a product 5 produced by the manufacturer 2 is to be checkable by the user 4. For this purpose the product 5 is provided with an identification feature 6 in the form of a serial number or an ID code and comprises, in a region 7 of its surface, random security features 8 (e.g. randomly arranged material parts, randomly applied colors, a random material structure, random sections of a hologram foil, etc.). The random security features 8 are optically capturable by means of a user reading device 9 of the user 4. Apart from the features on the product 5 itself, i.e. at least the identification feature 6 and the random security feature 8, the manufacturer 2 may additionally transfer information to the user 4 through a central database 10 which is independent of the product 5.

The definitive authentication check of the product 5 may be performed by recognition of the specific features, i.e. at least the identification feature 6 and the random security feature 8. For this purpose, a digital image 11 of the security features 8 which is stored in the database 10 is compared 13 with a digital image 12 of the physically available security features 8. In the use case illustrated, the features of the product 5 are formed by optically capturable characteristics. A known example thereof is the checking of finger prints. The process of storing of the security features 8 (or their image 11) is referred to as registration, and the process of the later comparison 13 is referred to as authentication. In the state of the art (FIG. 1) the security features 8 are digitized and stored in a database and thus registered in combination with the identification feature 6. To this end the manufacturer 2 needs a manufacturer reading device 14 performing the capturing and digitizing of the security features 8. For registration the digital image 11 is transmitted from the manufacturer reading device 14 along with the identification feature 6 to the database 10 and stored there, wherein the digital image 11 of the security feature 8 is linked to the identification feature 6. For authentication the user 4 captures the identification feature 6, e.g. by means of a user reading device 9, and transmits a request with the identification feature 6 to the database 10. If a corresponding combination is registered, the database 10 answers the request by indicating the registered digital image 11 of the security feature 8 which is linked to the received identification feature 6. It is compared 13 with the digital image 12 of the security feature 8 found on the product 5 which was generated by the user reading device 9 so as to determine the authenticity of the product 5. In the method illustrated in FIG. 1 the manufacturer 2 thus needs a manufacturer reading device 14 for the registration of the security feature 8, i.e. for the storing of a digital image 11 of the security feature 8 and the linking to the identification feature 6. The steps required for the registration have to be integrated into the production process and/or have to be performed by the manufacturer at any rate, and thus cause additional costs for every product produced.

The method and system in accordance with the invention as illustrated in FIG. 2, on the contrary, does without a manufacturer reading device 14. Here, the user 2 merely transmits the—generated and hence anyway known—identification feature 6, possibly with additional information concerning the target market, the sales period, the product type, or the product class, to the database 10 where it is stored. The registration of the security feature 8 instead takes place on the user side 3. In the illustrated case the registration is performed during the first authentication. Instead of a definitive authentication check with the comparison 13 of the digital images 11, 12, a preliminary authentication check 15 is performed. In this process, the digital image 12 of the security feature 8 and the identification feature 6 of the product 5 are captured by means of the user reading device 9 and supplied to the preliminary authentication check 15. By means of the identification feature 6 possible additional information stored for the preliminary authentication check 15 is queried from the database 10. If the identification feature 6 is not registered in the database 10, it—and hence also the product 5—is apparently not authentic and the preliminary authentication check 15 gives a negative result, i.e. the product 5 is a counterfeit 16. Otherwise, i.e. if the identification feature 6 is registered, a plausibility check is optionally performed by means of the additional information obtained from the database 10. If it is positive, the preliminary authentication check 15 altogether gives a positive result and the product 5 is assumed to be an original product. Starting out from this finding the security feature 8 and/or its digital image 12 is subsequently transmitted to the database 10 where it is registered. The database 10 stores the digital image 12 captured by the user reading device 9 and links it to the previously transmitted identification feature 6. In subsequent authentications of the same product 5 a definitive authentication check as illustrated in FIG. 1 may accordingly be performed by means of the registered features 6, 12.

The steps for registration to be performed by the user may therefore be summarized in general as follows, wherein the order of the steps may also deviate:

a) determining a random security feature of the product;

b) determining an identification feature of the product;

c) inquiring a data set of a database which comprises the identification feature;

d) If a corresponding data set was found and it is incomplete, performing a preliminary authentication check on the basis of the identification feature and/or additional information associated therewith.

e) If the preliminary authentication check gives a positive result, registering the random security feature and linking it to the data set and/or the identification feature.

If no data set was found in step c) or the preliminary authentication check in step e) gives a negative result, the registration is cancelled and the product is assumed to be a counterfeit. If the data set is complete in step d), i.e. already comprises a registered security feature, a definitive authentication check is performed, wherein for determining the authenticity the security feature determined in step a) is compared with the registered security feature.

1-12. (canceled)

13. A method for registering a random security feature of a product in a database on the basis of a reproducible identification feature of the product, wherein the random security feature is linked to the identification feature, comprising:
performing a preliminary authentication check of the product, comprising:
determining the identification feature of the product;
searching the database for an entry comprising the identification feature; and
determining that the preliminary authentication check is positive if the identification feature is found in the database; and
registering the random security feature if the preliminary authentication check is positive;
wherein any subsequent definitive authentication check of the product may use the registered random security feature.

14. The method of claim 13, wherein performing the preliminary authentication check further comprises taking into account additional information associated with the identification feature.

15. The method of claim 14, wherein the additional information comprises at least one of a target market, a sales period of the product, a reproducible security feature, and/or a current time and/or position of the product during the performing of the method.

16. The method of claim 13, wherein performing the preliminary authentication check further comprises checking plausibility of the random security feature to be registered.

17. The method of claim 16, wherein checking plausibility of the random security feature to be registered comprises determining a product type or a product class associated with the identification feature.

18. The method of claim 13, further comprising capturing the random security feature to be registered with a mobile user reading device and transmitting the captured random security feature from the mobile user reading device to the database during the performing of the method.

19. The method of claim 18, wherein the capturing is via a sensor of a commercially available mobile terminal.

20. The method of claim 18, wherein the capturing is via a smart phone, a tablet PC, or a mobile PC.

21. The method of claim 18, further comprising entering the captured random security feature in the database and linking the captured random security feature to the identification feature after a positive preliminary authentication check.

22. The method of claim 18, wherein the preliminary authentication check is performed locally at the mobile user reading device.

23. The method of claim 13, wherein the random security feature to be registered is formed by optically capturable characteristics and further comprising capturing optically the random security feature during the performing of the method.

24. The method of claim 13, further comprising, in advance of performing the preliminary authentication check:
generating the identification feature;
applying the identification feature to the product; and
registering the identification feature in the database.

25. The method of claim 24, wherein registering the identification feature in the database occurs during or before the production of the product.

26. An authentication system comprising:
a database storing links between identification features and security features of products; and
a mobile user reading device adapted to capture an identification feature and a random security feature on a product for authentication of the product;
wherein:
the mobile user reading device is adapted to perform and/or cause a preliminary authentication check of the product on the basis of the captured identification feature;
during use, the database is searched for an entry comprising the identification feature and, if the database comprises an entry comprising the identification feature, the preliminary authentication check is positive; and
if the preliminary authentication check is positive, the captured random security feature is registered in the database.

27. The authentication system of claim 26, wherein the identification feature is an identification code applied on the product.

28. The authentication system of claim 27, wherein the identification code comprises the identification feature encoded in a machine-readable format.

29. The authentication system of claim 28, wherein the identification feature is a one-dimensional bar code or a 2D code.
